(19) United States
(12) Patent Application Publication
(10) Pub. No.: US 2013/0173260 A1
(43) Pub. Date: Jul. 4, 2013

(54) DEVICE FOR ASSESSING ACCURACY OF STATEMENTS AND METHOD OF OPERATION

(71) Applicant: Michael Mansour Ahmadshahi, Laguna Niguel, CA (US)

(72) Inventor: Michael Mansour Ahmadshahi, Laguna Niguel, CA (US)

(21) Appl. No.: 13/729,332

(22) Filed: Dec. 28, 2012

Related U.S. Application Data
(60) Provisional application No. 61/580,826, filed on Dec. 28, 2011.

(51) Int. Cl. G10L 15/26

(52) U.S. Cl. CPC G10L 15/265
USPC 704/201

(57) ABSTRACT

A device receives voice and/or data from a speaker, such as a politician, and presents a signal indicative of the accuracy of the speaker's statements. The device maybe a mobile device, such as a smart phone, or a fixed device, such as a TV set. The device compares a speaker segment, automatically selected from the speaker statement, with a factual segment, automatically selected from a database comprising stored facts, and presents the accuracy of the speaker statement to the user of the device. The device may be configured so that the user may manually select the speaker segment to be assessed by the device.

### CROSS REFERENCE TO RELATED APPLICATIONS

The present patent application is a formalization of a previously filed co-pending provisional patent application entitled “Politician BS-O-Meter,” filed on Dec. 28, 2011, as U.S. patent application Ser. No. 61/580,826 by the inventor named in this application. This patent application claims the benefit of the tiling date of the cited provisional patent application according to the statutes and rules governing provisional patent applications, particularly 35 USC §119 and 37 CFR §1.78. The specification and drawings of the cited provisional patent application are specifically incorporated herein by reference.

### COPYRIGHT

A portion of the disclosure of this patent document contains material which is subject to copyright protection. The owner has no objection to the facsimile reproduction by anyone of the patent disclosure, as it appears in the Patent and Trademark Office files or records, but otherwise reserves all copyright rights whatsoever.

### FIELD OF INVENTION

This invention is related to a device, including method of operation, for assessing accuracy of statements made by a speaker. In particular, the device receives speaker voice and/or data, compares it to facts stored in a database, and presents an accuracy signal.

### BACKGROUND

The present state of the art in analyzing and synthesizing human speech in variety of applications is well known to skilled artisans. For instance, U.S. Pat. No. 7,822,611, incorporated herein by reference in its entirety, describes a speaker intent analysis system and method for validating the truthfulness and intent of a plurality of participants' responses to questions. A computer stores, retrieves, and transmits a series of questions to be answered audibly by participants. Tire participants' answers are received by a data processor. The data processor analyzes and records the participants' speech parameters for determining the likelihood of dishonesty. In addition to analyzing participants' speech parameters for distinguishing stress or other abnormality, the processor may be equipped with voice recognition software to screen responses that while not dishonest, are indicative of possible malfeasance on the part of the participants. Once the responses are analyzed, the processor produces an output that is indicative of the participant's credibility. The output may be sent to proper parties and/or devices such as a web page, computer, e-mail, PDA, pager, database, report, etc. for appropriate action.

In addition, various mobile devices are available on the market where the processor, included in the mobile device, executes one or more applications to access databases which reside either in the mobile device, or remote servers through the Internet. U.S. Pat. App. No. 20070168419, incorporated herein by reference in its entirety, is an example of a device accessing a remote database via, a network channel. It describes a network media channel that can be used by the subscribers of the channel to share media files based on ad-hoc specifications. Temporal, spatial, channel identity and mask components, or any combination thereof, are among the specifications that subscribers can use to create ad-hoc specifications. A transmitting subscriber creates a media the and a kernel containing the ad-hoc specifications, wherein the media file is stored according to the first kernel. Access to the media file is according to the first kernel. A receiving subscriber can in turn create a second kernel to introduce additional refinements, to the ad-hoc specification and be notified according to the first and second kernel. The receiving subscriber may retrieve the media file upon reception of the notice. U.S. Pat. No. 8,275,419, incorporated herein by reference in its entirety, is an example of a device utilizing mobile applications for advertisement. It describes a method for delivering advertisements to mobile devices includes integrating an ad position within an application executable from a mobile device, wherein the ad position remains substantially constant in a location on a screen of the mobile device as viewed by a user throughout use of the application, including an ad call associated with the ad position, in response to executing the application, causing the ad call to retrieve an advertisement from an ad server, and receiving the advertisement into the ad position by the mobile device for display to the user.

There are numerous technologies utilizing computers to analyze or make use of human speech. For example, there are myriad of speech recognition software on the market which will convert an oral message into a text format. There are also numerous databases containing facts that maybe made, purchased, or otherwise accessible through the Internet, such as those provided by the Google company. Public speakers, such as politicians, routinely make inaccurate statements to the audience, which serve to support their position. The device of the present invention and method of operation could be used to easily ascertain the accuracy of such statements.

### SUMMARY

The present invention discloses a device, including method of operation, where a speaker's voice and/or data is converted into speaker text comprising one or more paragraphs. The device stores the speaker text and selects a segment of the text to be assessed for accuracy. The device accesses a database, comprising stored facts, and retrieves factual segments to be compared with the speaker segment. The device determines an accuracy factor and generates a communication signal indicative of the accuracy factor to be presented via a communications means.

In one aspect, a method for assessing accuracy of statements made by a speaker is disclosed. The method comprises receiving at least one of speaker voice and speaker data generated by the speaker, converting the at least one of speaker voice and speaker data into speaker text, storing the speaker text, selecting a speaker segment from the speaker text, accessing a database comprising stored facts, retrieving a factual segment from the database, determining an accuracy factor from the factual segment and speaker segment, generating a communication signal indicative of the accuracy factor, and communicating the communication signal.

Preferably, the step of selecting a speaker segment comprises selecting an alphanumeric segment. Preferably, the alphanumeric segment is a text string comprising a number.

Preferably, the method further comprises receiving at least one of user voice segment and user data segment generated by a user, converting the at least one of user voice segment and user data segment into user segment and wherein the step of selecting a speaker segment comprises using the user segment. Preferably, the database is stored in at least one of local memory and remote memory.

In another aspect, a device for assessing accuracy of statements made by a speaker is disclosed. The device comprises a receiver configured to receive at least one of speaker voice and speaker data, a processor coupled with the receiver, said processor including a plurality of programming code operable on the processor, wherein said processor is configured to execute a programming code to convert the at least one of speaker voice and speaker data into speaker text, execute a programming code to store the speaker text, execute a programming code to select a speaker segment from the speaker text, execute a programming code to access a database comprising stored facts, execute a programming code to retrieve as factual segment from the database, execute a programming code to determine an accuracy factor from the factual segment and speaker segment, and execute as programming code to generate a communication signal indicative of the accuracy factor. The device further comprises a communication means coupled with the processor, said communication means configured to communicate the communication signal.

Preferably, the communication means comprises at least one of media display and loudspeaker. Preferably, the speaker segment comprises an alphanumeric segment. Preferably, the alphanumeric segment is a text string comprising a number.

Preferably the receiver is further configured to receive at least one of user voice segment and user data segment generated by a user and wherein the processor is further configured to execute a programming code to convert the at least one of user voice segment and user data segment into user segment and to use the user segment instead of the speaker segment. Preferably, the database is stored in at least one of local memory and remote memory. Preferably, the remote memory comprises one or more servers accessible via the Internet.

### DESCRIPTION OF THE DRAWINGS

FIG. 1 shows a preferred method of assessing accuracy of statements made by a speaker.

FIG. 2 shows a preferred embodiment of a device operative to assess accuracy of statements made by a speaker

### DETAILED DESCRIPTION OF THE PRESENTLY PREFERRED EMBODIMENTS

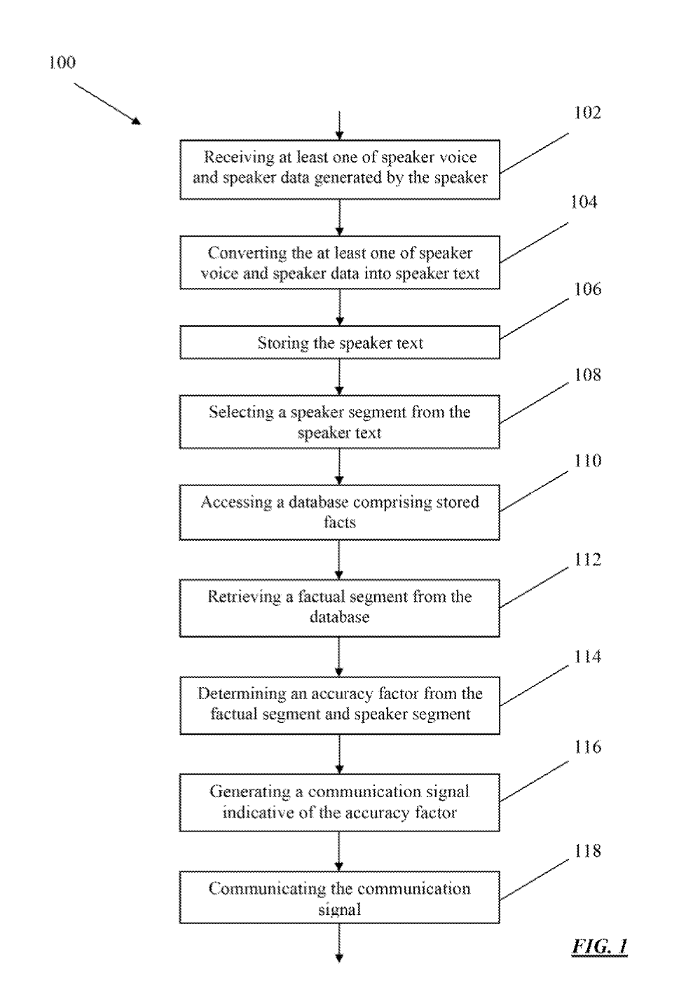

FIG. 1 shows a flow diagram 100 of one preferred method of assessing accuracy of statements made by a speaker. According to this embodiment, the method comprises receiving at least one of speaker voice and speaker data generated by the speaker at 102. The method further comprises, converting the at least one of speaker voice and speaker data into speaker text at 104. The method further comprises, storing the speaker text at 106. The method further comprises, selecting a speaker segment from the speaker text at 108. The method further comprises, accessing a database comprising stored facts at 110. The method further comprises, retrieving a factual segment from the database at 112. The method further comprises, determining an accuracy factor from the factual segment and speaker segment at 114. The method further comprises, generating a communication signal indicative of the accuracy factor at 116. The method further comprises, communicating the communication signal at 118.

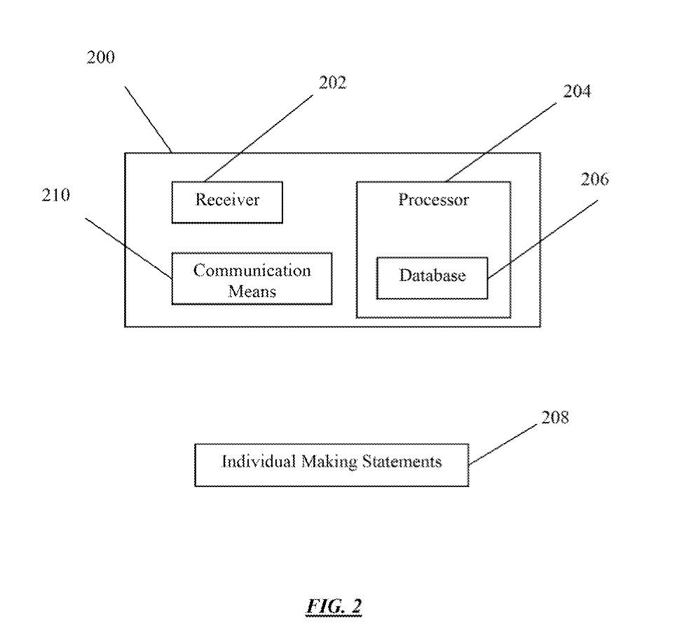

FIG. 2 shows a schematic diagram 200 of a device implementing the method described in FIG. 1 according to a preferred embodiment. The device 200 comprises a receiver 202 which may be used to receive at least one of speaker voice and speaker data generated by a speaker, such as a politician at 208. The device further comprises a processor 204 which includes plurality of programming code operable on the processor 204. The processor 204 is configured to execute a programming code to convert the at least one of speaker voice and speaker data into speaker text. The processor 204 is further configured to execute a programming code to store the speaker text in its internal memory. The processor 204 is further configured to execute a programming code to select a speaker segment from the speaker text. The processor 204 is further configured to execute a programming code to access a database 206 which comprises stored facts. In this preferred embodiment, the database 206 is stored in the internal memory of the processor 204. In an alternative embodiment, the database 206 resides in remote servers such those that maybe made, purchased, or otherwise accessed through the Internet, such as those provided by the Google company. The processor 204 is further configured to execute a programming code to retrieve a factual segment from the database 206. The processor 204 is further configured to execute a programming code to determining an accuracy factor from the factual segment and speaker segment. The accuracy factor may be obtained through a formula such as Percent error=[(Actual Figure−Stated Figure)/Actual Figure]×100%. The processor 204 is further configured to execute a programming code to generate a communication signal indicative of the accuracy factor. The device 200 further comprises a communication means 210 which may be used to communicate the communication signal generated by the processor 204. The communications means maybe the display screen of the mobile device or a TV set.

Utilizing the device 200 described above, two embodiments of the method of assessing accuracy of statements made by a speaker are now described. According to one embodiment the speaker 208 makes a speech which comprises several statements and the receiver 202 receives the statements generated by the speaker 208. The processor 204 executes a programming code which converts the statements into text. The processor 204 then executes a programming code which selects a speaker segment from the text. The speaker segment comprises time and place of occurrence of past and future events, and actual or statistical figures pertaining to the past and future events. For instance the speaker segment includes the country's deficit, for instance $100 billion for the year 2011. The processor 204 then accesses the database 206 which comprises stored facts and retrieves a factual segment from the database 206. The actual deficit, i.e., the factual segment, is $120 billion for the year 2011. The processor 204 then determines an accuracy factor according to Percent error=[($120 billion−$100 billion)/$120 billion]×100% which is equal to 16.7%. The processor 204 executes a programming code that generates a communication signal indicative of the percent error which is equal to 16.7%. The device 200 then presents the result utilizing the communication means 210.

According to another embodiment the speaker 208 makes a speech comprises several statements and the receiver 202 receives the statements generated by the speaker 208. The processor 204 executes a programming code which converts the statements into text. After hearing the politician making a statement that the country's defense budget is $500 billion for the year 2011, the user of the device 200 utters the phrase “country's defense budget.” The receiver 202 is further configured to receive the user voice segment, i.e., the phrase “country's defense budget.” and the processor 204 is further configured to execute a programming code to convert the user voice segment into user segment and to use the user segment instead of the speaker segment. The processor 204 then accesses the database 206 which comprises stored facts and retrieves a factual segment from the database 206. The actual defense budget, i.e., the factual segment, is $800 billion for the year 2011. The processor 204 then determines an accuracy factor according to Percent error=[($800 billion−$500 billion)/$800 billion]×100% which is equal to 37.5%. The processor 204 executes a programming code that generates a communication signal indicative of the percent error which is equal to 37.5%. The device 200 then presents the result utilizing the communication means 210.

The foregoing explanations, descriptions, illustrations, examples, and discussions have been set forth to assist the reader with understanding this invention and further to demonstrate the utility and novelty of it and are by no means restrictive of the scope of the invention. It is the following claims, including all equivalents, which are intended to define the scope of this invention.

What is claimed is:

1. A method for assessing accuracy of statements made by a speaker, comprising:
(i) receiving at least one of speaker voice and speaker data generated by the speaker;
(ii) converting the at least one of speaker voice and speaker data into speaker text;
(iii) storing the speaker text;
(iv) selecting a speaker segment from the speaker text;
(v) accessing a database comprising stored facts;
(vi) retrieving a factual segment from the database;
(vii) determining an accuracy factor from the factual segment and speaker segment;
(viii) generating a communication signal indicative of the accuracy factor; and
(ix) communicating the communication signal.

2. The method of claim 1, wherein the step of selecting a speaker segment comprises selecting an alphanumeric segment.

3. The method of claim 2, wherein the alphanumeric segment is a text string comprising a number.

4. The method of claim 1, further comprising:
(x) receiving at least one of user voice segment and user data segment generated by a user;
(xi) converting the at least one of user voice segment and user data segment into user segment and wherein the step of selecting a speaker segment comprises using the user segment.

5. The method of claim 1, wherein the database is stored in at least one of local memory and remote memory.

6. A device for assessing accuracy of statements made by a speaker, comprising:
a receiver configured to receive at least one of speaker voice and speaker data;
(b) a processor coupled with the receiver, said processor including a plurality of programming code operable on the processor, wherein said processor is configured to:
(i) execute a programming code to convert the at least one of speaker voice and speaker data into speaker text;
(ii) execute a programming code to store the speaker text;
(iii) execute a programming, code to select a speaker segment from the speaker text;
(iv) execute a programming code to access a database comprising stored facts;
(v) execute a programming code to retrieve a factual segment from the database;
(vi) execute a programming code to determine an accuracy factor from the factual segment and speaker segment; and
(vii) execute a programming code to generate a communication signal indicative of the accuracy factor; and
(c) a communication means coupled with the processor, said communication means configured to communicate the communication signal.

7. The device of claim 6, wherein said communication means comprises at least one of media display and loudspeaker.

8. The device of claim 6, wherein the speaker segment comprises an alphanumeric segment.

9. The device of claim 8, wherein the alphanumeric segment is a text string comprising a number.

10. The device of claim 6, wherein the receiver is further configured to receive at least one of user voice segment and user data segment generated by a user and wherein the processor is further configured to;
(viii) execute a programming code to convert the at least one of user voice segment and user data segment into user segment and to use the user segment instead of the speaker segment.

11. The device of claim 6, wherein the database is stored in at least one of local memory and remote memory.

12. The device of claim 11, wherein the remote memory comprises one or more servers accessible via the Internet.
